(19) United States
(12) Patent Application Publication
(10) Pub. No.: US 2006/0238845 A1
(43) Pub. Date: Oct. 26, 2006

(54) Scanning optical system, optical scanning device, and image forming apparatus

(76) Inventors: Hiromichi Atsuumi, Kanagawa (JP); Taku Amada, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/404,913

(22) Filed: Apr. 17, 2006

(30) Foreign Application Priority Data
Apr. 20, 2005 (JP) 2005-122603
Feb. 3, 2006 (JP) 2006-027074

(51) Int. Cl. G02B 26/08

(52) U.S. Cl. 359/196; 359/205

(57) ABSTRACT

A scanning optical system deflects a light flux emitted by a light source by an optical deflector, and focuses the light flux on a surface to be scanned through a scanning lens. The scanning optical system includes a kink producing unit that produces a kink in the scanning lens.

### CROSS-REFERENCE TO RELATED APPLICATIONS

The present document incorporates by reference the entire contents of Japanese priority document, 2005-122603 filed in Japan on Apr. 20, 2006 and 2006-027074 filed in Japan on Feb. 3, 2006.

### BACKGROUND OF THE INVENTION

1. Field of the Invention

The present invention relates to a scanning optical system, an optical scanning device, and an image forming apparatus, that can be applied to a laser copier, a laser printer, a laser facsimile, and the like.

2. Description of the Related Art

The laser color printers, digital color copiers, etc. that are currently popular produce high quality images with high-density colors. However, color shift is an inevitable consequence of attaining high quality images with high-density colors.

To find a solution for the problem related to color shift, Japanese Patent Laid-Open Publication No. 3343465 discloses a scanning optical system having a configuration shown in FIG. 1A and FIG. 1B that adjusts the bend of a scan line. FIG. 2 is a schematic for explaining a conventional scan line bending adjustment. As shown in FIG. 2, the bend of the scan line is achieved by using a second scanning lens 6, which is an oblong lens, whose long side is depressed in a substantially mid portion in a sub-scanning direction.

Japanese Patent Laid-Open Publication No. 2002-182145 discloses another scanning optical system in which adjusting units (machine screws) are provided at three places along a main-scanning direction of the oblong lens, and which also adjusts a higher-order component of the scan line bending.

However, in the method disclosed in Japanese Patent Laid-Open Publication No. 3343465, when the scan line bending is as shown in FIG. 4A prior to adjustment, a 2-dimensionally curved scan line bending can be adjusted so that the scan line bending shown in FIG. 4B can be obtained. However, a scan line bending of a higher-order component cannot be adjusted.

In the method disclosed in Japanese Patent Laid-Open Publication No. 2002-182145, providing the adjusting units at three places pushes up the cost substantially in mass production.

### SUMMARY OF THE INVENTION

It is an object of the present invention to at least solve the problems in the conventional technology.

A scanning optical system according to one aspect of the present invention deflects a light flux emitted by a light source by an optical deflector, and focuses the light flux on a surface to be scanned through a scanning lens. The scanning optical system includes a kink producing unit that produces a kink in the scanning lens.

A scanning optical system according to another aspect of the present invention deflects a light flux emitted by a light source by an optical deflector, and focuses the light flux on a surface to be scanned through a scanning lens. The scanning optical system includes a pressing unit that is disposed at a substantially mid portion of the scanning lens. A kink is produced on the scanning lens by pressing the scanning lens with the pressing unit.

An optical scanning device according to still another aspect of the present invention includes a scanning optical system that deflects a light flux emitted by a light source by an optical deflector, and focuses the light flux on a surface to be scanned through a scanning lens. The scanning optical system includes a kink producing unit that produces a kink in the scanning lens.

An optical scanning device according to still another aspect of the present invention includes a scanning optical system that deflects a light flux emitted by a light source by an optical deflector, and focuses the light flux on a surface to be scanned through a scanning lens. The scanning optical system includes a pressing unit that is disposed at a substantially mid portion of the scanning lens. A kink is produced on the scanning lens by pressing the scanning lens with the pressing unit.

An image forming apparatus according to still another aspect of the present invention includes an optical scanning device that includes a scanning optical system that deflects a light flux emitted by a light source by an optical deflector, and focuses the light flux on a surface to be scanned through a scanning lens. The scanning optical system includes a kink producing unit that produces a kink in the scanning lens.

An image forming apparatus according to still another aspect of the present invention includes an optical scanning device that includes a scanning optical system that deflects a light flux emitted by a light source by an optical deflector, and focuses the light flux on a surface to be scanned through a scanning lens. The scanning optical system includes a pressing unit that is disposed at a substantially mid portion of the scanning lens. A kink is produced on the scanning lens by pressing the scanning lens with the pressing unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is a top view and FIG. 1B is a side view of a configuration of a scanning optical system according to a first embodiment of the present invention;

FIG. 2 is a schematic for explaining a conventional scan line bending adjustment;

FIG. 3A is a sectional view of a second scanning lens 6 and parts in close proximity to the second scanning lens 6 according to the first embodiment taken along an optical axis direction, and FIG. 3B is a sectional view taken in a substantially mid portion along the long edge of the second scanning lens 6 along a sub-scanning plane;

FIG. 4A, FIG. 4B, and FIG. 4C are graphs for explaining a relation between a scan line bending and an image height;

FIG. 5 is a graph for explaining the relation between the scan line bending and the image height;

FIG. 6A is a sectional view of the second scanning lens 6 and parts in close proximity to the second scanning lens 6 according to a second embodiment of the present invention taken along an optical axis direction, and FIGS. 6B and 6C are sectional views taken in a substantially mid portion along the long edge of the second scanning lens 6 along a sub-scanning plane;

FIG. 7 is a sectional view taken in a substantially mid portion along the long edge of the second scanning lens 6 according to a third embodiment of the present invention along a sub-scanning plane; and

FIG. 8A is a sectional view of the second scanning lens 6 and parts in close proximity to the second scanning lens 6 according to a fourth embodiment of the present invention taken along an optical axis direction, and FIGS. 8B and 8C are sectional views taken in a substantially mid portion along the long edge of the second scanning lens 6 along a sub-scanning plane.

### DETAILED DESCRIPTION OF THE PREFERRED EMBODIMENTS

Exemplary embodiments of the present invention will be explained in detail below with reference to the accompanying drawings.

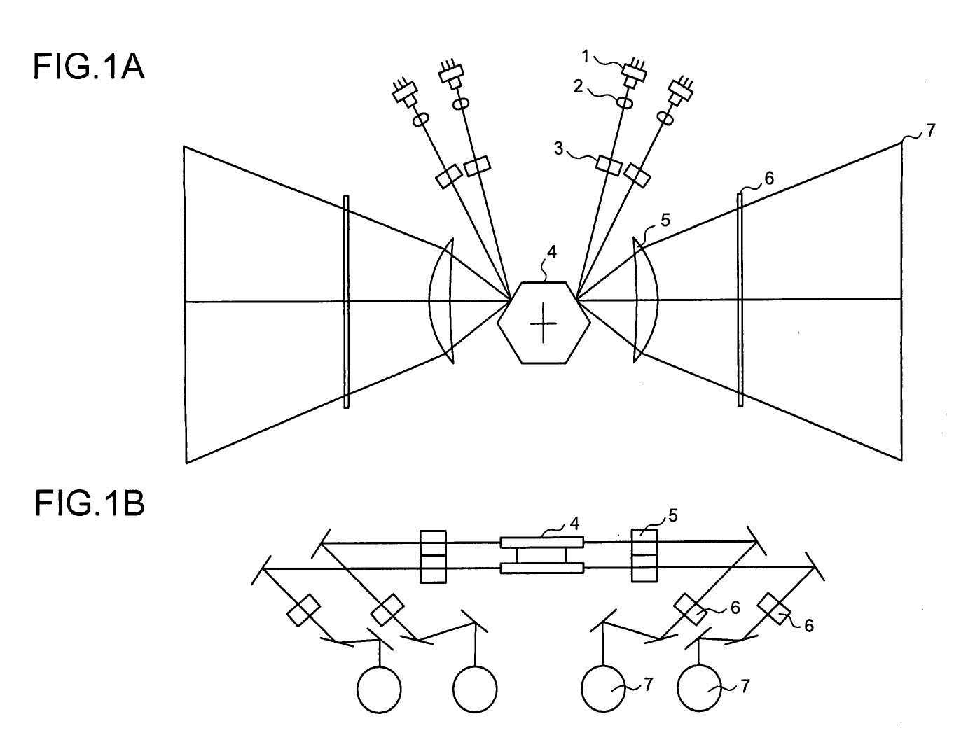

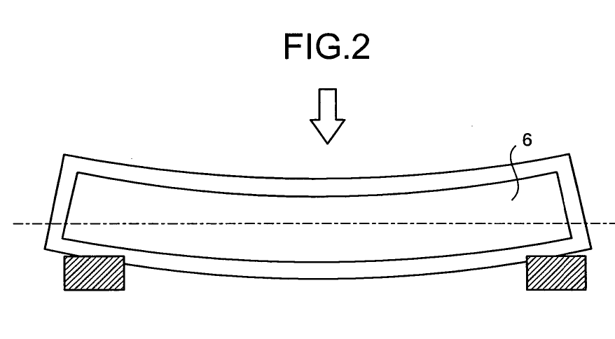

FIG. 1A is a top view and FIG. 1B is a side view of a configuration of the scanning optical system according to a first embodiment of the present invention. A light flux emitted from a light source 1 is coupled to form a substantially parallel light flux by a coupling lens 2. The coupled light flux enters a cylindrical lens 3, which causes the light flux to converge as a line image, which is elongated in the main scanning direction before entering an optical deflector 4. The light flux is deflected by the optical deflector 4, and passes through a first scanning lens 5 and a second scanning lens 6 and converges to form a beam spot on a surface to be scanned 7.

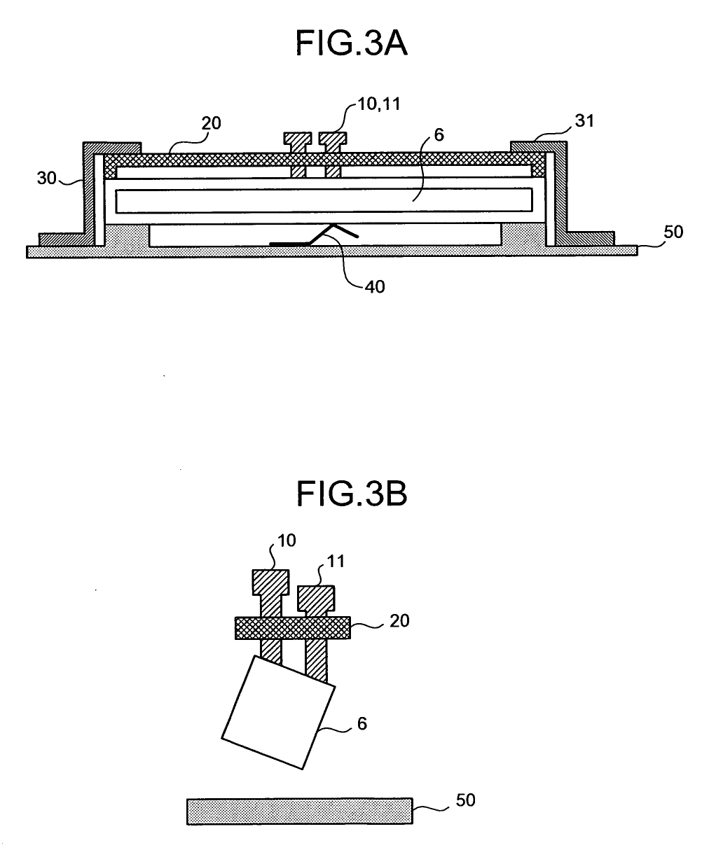

FIG. 3A and FIG. 3B are sectional views of the second scanning lens 6 and parts in close proximity to the second scanning lens 6 according to the first embodiment. FIG. 3A is a sectional view taken along an optical axis direction and FIG. 3B is a sectional view taken in a substantially mid portion along the long edge of the second scanning lens 6 along a sub-scanning plane.

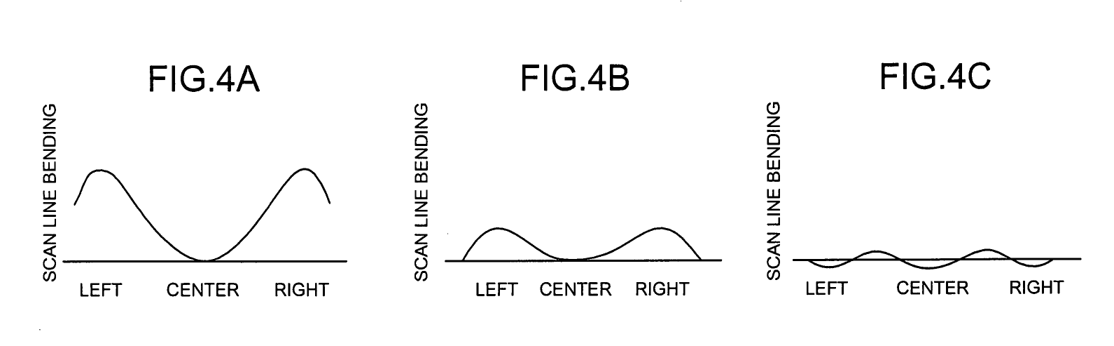

The two ends of the second scanning lens 6 are sandwiched between a housing 50 and a sheet metal 20 composed of iron and secured by plate springs 30 and 31. Two screws 10 and 11 are provided in the mid portion of the second scanning lens 6 for adjusting the scan line bending. The 2-dimensionally curved scan line bending is adjusted by first tightening the screws 10 and 11 fully (and parallel with the sub-scanning direction) in the sub-scanning direction. When the scan line bending is as shown in FIG. 4A, this adjustment yields the scan line bending shown in FIG. 4B. Next, by keeping the position of the screw 10 fixed and making minute adjustments to the level of tightness of the screw 11, the magnitude of the scan line bending of the high-order component can be further reduced. In other words, the scan line bending shown in FIG. 4C can be realized from the scan line bending shown in FIG. 4B.

In other words, according to the first embodiment, the high-order component of the scan line bending is adjusted by contorting the second scanning lens 6 by keeping the levels of tightness of the screws 10 and 11 different. The screws 10 and 11 are used as a pressing unit (kink producing unit). However, the pressing unit is not limited to the screws 10 and 11 and may include other means that can produce a similar effect.

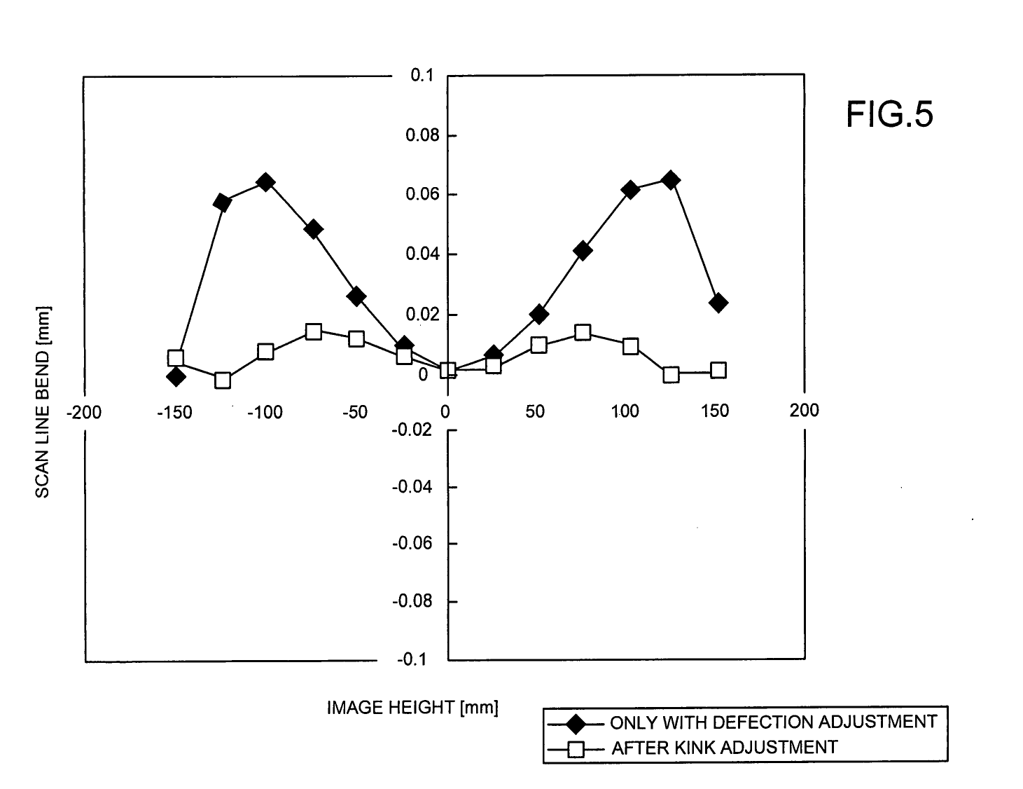

FIG. 5 is a schematic of simulation results. In one simulation, the contour of the second scanning lens 6 is intentionally flexed, and the screws 10 and 11 are tightened fully (and parallel with the sub-scanning direction) in the sub-scanning direction, and the resulting scan line bending is calculated (see the drawing corresponding to “Only with deflection adjustment” in FIG. 5). In a second simulation, a kink is produced in the second scanning lens 6 by minutely adjusting the level of tightness of the screw 11, and the resulting scan line bending is calculated (see the drawing corresponding to “After kink adjustment” in FIG. 5). As shown in FIG. 5, the scan line bending value obtained after kink adjustment employed according to the first embodiment is insignificant as compared to when adjustment is made only for deflection employed in the conventional scanning optical system. The present embodiment presupposes that the sheet metal 20 is sufficiently more rigid compared to the second scanning lens 6, which may be made of resin, for instance.

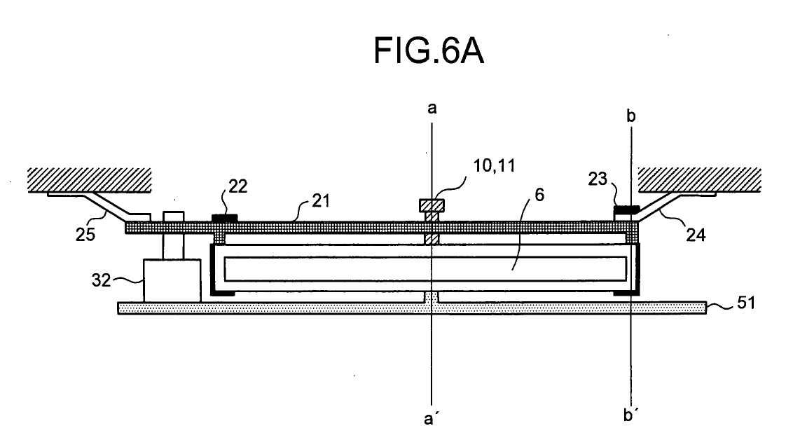

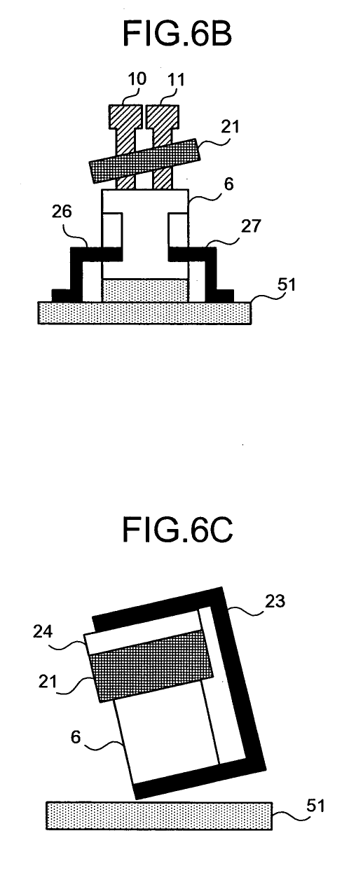

According to the first embodiment, the two ends of the second scanning lens 6 were secured and only the mid portion is contorted. The scanning optical system according to a second embodiment of the present invention is explained is explained next. FIG. 6A, FIG. 6B, and FIG. 6C are sectional views of the second scanning lens 6 and parts in close proximity to the second scanning lens 6 of the scanning optical system according to the second embodiment. FIG. 6A is a sectional view taken along the optical axis direction. FIG. 6B is and FIG. 6C are sectional views taken in a substantially mid portion along the long edge of the second scanning lens 6 along the sub-scanning plane.

As shown in FIG. 6A, the second scanning lens 6 is sandwiched between a sheet metal 21 and plate springs 22 and 23. A housing 51 has a protrusion in alignment with a substantially mid portion of the second scanning lens 6. The second scanning lens 6 rests on the protrusion. The sheet metal 21 is secured to the housing 51 by plate springs 24 and 25. The reference numeral 32 denotes a stepping motor, which is a mechanism that lifts up and lowers the left end of the sheet metal 21 to adjust the inclination of the second scanning lens 6, with the protrusion of the housing 51 functioning as a fulcrum. In other words, apart from the scan line bending, the scan line inclination can also be adjusted in the second embodiment. In the second embodiment, the mid portion of the second scanning lens 6 is secured (by plate springs 26 and 27), and the scan line bending is adjusted by producing kinks at either end of the second scanning lens 6 (see FIG. 6B, which is a sectional view taken along line a-a′ of FIG. 6A, and 6C, which is a sectional view taken along line b-b′ of FIG. 6A). The second embodiment also presupposes that the sheet metal 21 is more rigid compared to the second scanning lens 6. The second embodiment uses the adjustment method similar to that of the first embodiment, in which the two screws 10 and 11 are used for adjusting the 2-dimensionally curved scan line bending as well as the high-order component.

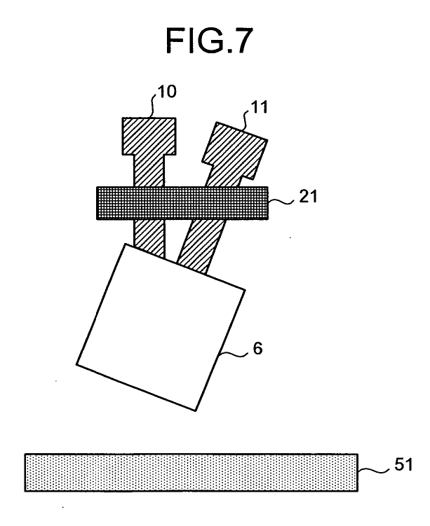

According to the first embodiment (see FIG. 3B) and the second embodiment (see FIG. 6B), the both screws 10 and 11 are parallel with the sub-scanning direction. As shown in FIG. 7, in the scanning optical system according to a third embodiment of the present invention, the screw 10 is parallel with the sub-scanning direction and the screw 11 is inclined with respect to the sub-scanning direction. In other words, a kink producing unit, which uses a different method for contorting the second scanning lens 6, can be used.

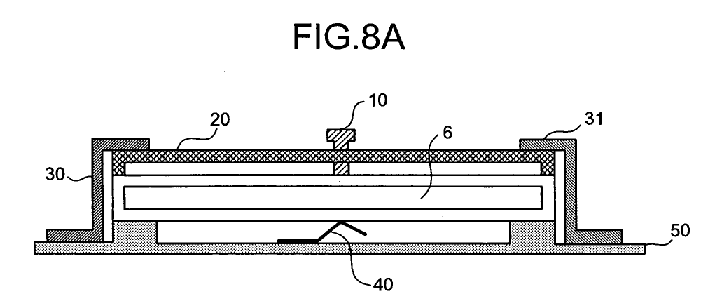

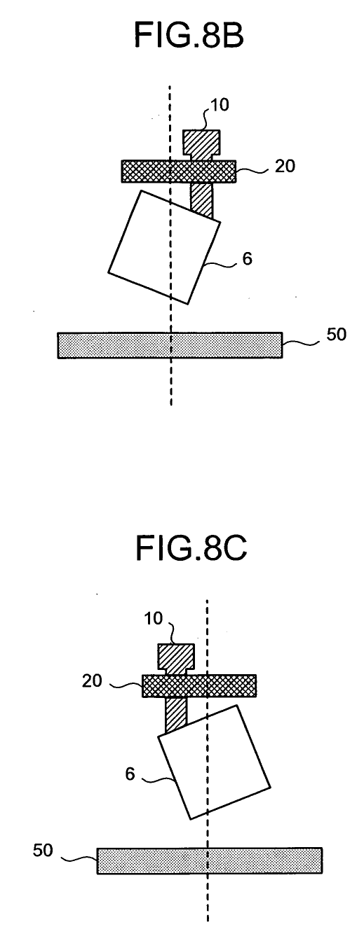

The scanning optical system according to a fourth embodiment of the present invention is explained next. FIG. 8A, FIG. 8B, and FIG. 8C are sectional views of the second scanning lens 6 and parts in close proximity to the second scanning lens 6 of the scanning optical system according to the fourth embodiment. FIG. 8A is a sectional view taken along the optical axis direction. FIG. 8B is and FIG. 8C are sectional views taken in a substantially mid portion along the long edge of the second scanning lens 6 along the sub-scanning plane. The basic configuration of the fourth embodiment is similar to that of the first embodiment (see FIG. 3A). However, in the fourth embodiment, there is only one screw 10 but a plurality of screw holes are provided in the sheet metal 20. As shown in FIG. 8B, if the screw 10 is inserted into a screw hole which is a little towards the surface to be scanned with respect to the mid portion of the second scanning lens 6 in the optical axis direction, the long edge of the second scanning lens 6 towards the side of the surface to be scanned contorts. Similarly, as shown in FIG. 8C, if the screw 10 is inserted into a screw hole which is a little towards the deflector end with respect to the mid portion of the second scanning lens 6 in the optical axis direction, the long edge of the second scanning lens 6 towards the deflector end contorts. Thus, in the fourth embodiment, a plurality of screw holes is provided in the sheet metal 20. According to the molding error, etc. of the second scanning lens 6, it is determined beforehand whether the screw 10 is to be inserted into which screw hole so that high-order component of the scan line bending can be corrected. Consequently, by selecting a suitable screw hole from among the available screw holes, the 2-dimensionally curved scan line bending as well as the scan line bending of high-order component is adjusted.

Thus, in the scanning optical system according to first to fourth embodiments, fewer steps are required for adjusting the 2-dimensionally curved scan line bending as well as the scan line bending of high-order component. Consequently, the images produced are defect-free. Further, the adjustment step is completed in a very short time, thus keeping the cost down. Further, the number of parts is brought down.

By providing one or a plurality of scanning optical system according to the present invention in a tandem optical system, the scan line bending of each scanning optical system can be reduced. Consequently, an optical scanning device in which color shift is negligible is realized.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

According to an embodiment of the present invention, fewer steps are required for adjusting the 2-dimensionally curved scan line bending as well as the scan line bending of high-order component. Consequently, the images produced are defect-free. Further, the adjustment step is completed in a very short time, thus keeping the cost down. Further, the number of parts is brought down.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A scanning optical system that deflects a light flux emitted by a light source by an optical deflector, and focuses the light flux on a surface to be scanned through a scanning lens, the scanning optical system comprising:
a kink producing unit that produces a kink in the scanning lens.

2. A scanning optical system that deflects a light flux emitted by a light source by an optical deflector, and focuses the light flux on a surface to be scanned through a scanning lens, the scanning optical system comprising:
a pressing unit that is disposed at a substantially mid portion of the scanning lens, wherein
a kink is produced on the scanning lens by pressing the scanning lens with the pressing unit.

3. The scanning optical system according to claim 2, wherein
at least one pressing unit is provided.

4. The scanning optical system according to claim 2, wherein
at least two pressing unit is provided.

5. The scanning optical system according to claim 2, wherein
the pressing unit produces a kink on the substantially mid portion of the scanning lens.

6. The scanning optical system according to claim 2, wherein
the pressing unit produces a kink on both ends of the scanning lens.

7. An optical scanning device comprising:
a scanning optical system that deflects a light flux emitted by a light source by an optical deflector, and focuses the light flux on a surface to be scanned through a scanning lens, wherein
the scanning optical system includes a kink producing unit that produces a kink in the scanning lens.

8. The optical scanning device according to claim 7, wherein
a plurality of the scanning optical systems is provided.

9. An optical scanning device comprising:
a scanning optical system that deflects a light flux emitted by a light source by an optical deflector, and focuses the light flux on a surface to be scanned through a scanning lens, wherein
the scanning optical system includes a pressing unit that is disposed at a substantially mid portion of the scanning lens, and
a kink is produced on the scanning lens by pressing the scanning lens with the pressing-unit.

10. The optical scanning device according to claim 9, wherein
a plurality of the scanning optical systems is provided.

11. An image forming apparatus comprising:
an optical scanning device that includes a scanning optical system that deflects a light flux emitted by a light source by an optical deflector, and focuses the light flux on a surface to be scanned through a scanning lens, wherein
the scanning optical system includes a kink producing unit that produces a kink in the scanning lens.

12. An image forming apparatus comprising:
an optical scanning device that includes a scanning optical system that deflects a light flux emitted by a light source by an optical deflector, and focuses the light flux on a surface to be scanned through a scanning lens, wherein
the scanning optical system includes a pressing unit that is disposed at a substantially mid portion of the scanning lens, and
a kink is produced on the scanning lens by pressing the scanning lens with the pressing unit.
